(19) United States
(12) Patent Application Publication
(10) Pub. No.: US 2002/0127494 A1
(43) Pub. Date: Sep. 12, 2002

(54) Process for preparing a multi-layer circuit assembly

(76) Inventors: Lance C. Sturni, Allison Park, PA (US); Kevin C. Olson, Gibsonia, PA (US)

Correspondence Address: PPG INDUSTRIES INC, INTELLECTUAL PROPERTY DEPT, ONE PPG PLACE, PITTSBURGH, PA, 15272, US

(21) Appl. No.: 09/802,001

(22) Filed: Mar. 8, 2001

(51) Int. Cl. G03C 5/00

(52) U.S. Cl. 430/314

(57) ABSTRACT

A process for fabricating a multi-layer circuit assembly is provided comprising the following steps:

(a) providing a perforate metal core;

(b) applying a dielectric polymer onto all exposed surfaces of the metal core to form a conformal coating of substantially uniform thickness on all exposed surfaces of the metal core;

(c) ablating the surface of the dielectric polymer in a predetermined pattern to expose sections of the metal core;

(d) applying a layer of metal to all surfaces to form metallized vias through the metal core; and

(e) applying a resinous photosensitive layer to the metal layer.

Additional processing steps such as circuitization may be included.

Circuit assemblies produced by the process of the present invention comprise component layers having high via density and thermal coefficients of expansion that are compatible with those of semiconductor chips and rigid wiring boards which may be attached as components of the circuit assembly.

### FIELD OF THE INVENTION

The present invention relates to the field of electronic circuitry, and in particular to preparation of multi-layer circuit assemblies such as chip scale packages.

### BACKGROUND OF THE INVENTION

An electronic circuit package, or assembly, comprises many individual components including, for example, resistors, transistors, capacitors, etc. These components are interconnected to form circuits, and circuits are likewise interconnected to form units having specific functions. In microelectronic circuit packages, circuits and units are prepared in packaging levels of increasing scale. The smallest scale packaging levels are typically semiconductor chips housing multiple microcircuits and/or other components. Such chips are usually made from ceramics, silicon, and the like. Intermediate package levels (“chip carriers”) comprising multi-layer substrates may have attached thereto a plurality of small-scale chips housing many microelectronic circuits. In turn, these intermediate package levels are themselves attached to larger scale circuit cards, motherboards, and the like. The intermediate package levels serve several purposes in the circuit assembly including structural support, transitional integration of the smaller scale microcircuits and circuits to larger scale boards, and the dissipation of heat from the circuit assembly.

Substrates used in conventional intermediate package levels have included ceramic, fiberglass reinforced polyepoxides, and polyimides. These substrates, while offering sufficient rigidity to provide structural support to the circuit assembly, typically have thermal coefficients of expansion much different than that of the microelectronic chips being attached thereto. As a result, failure of the circuit assembly after repeated use is a risk due to failure of adhesive joints between the layers of the assembly.

Likewise, dielectric materials used on the substrates must meet several requirements, including conformality, flame resistance, and compatible thermal expansion. Conventional dielectrics include polyimides, polyepoxides, phenolics, and fluorocarbons. These polymeric dielectrics typically have thermal coefficients of expansion much higher than that of the adjacent layers.

U.S. Pat. Nos. 5,224,265 and 5,232,548 disclose methods of fabricating multi-layer thin-film wiring structures for use in circuit assemblies. The dielectric applied to the core substrate is preferably a fully cured and annealed thermoplastic polymer such as polytetrafluoroethylene, polysulfone, or polyimide-siloxane, preferably applied by lamination.

U.S. Pat. No. 5,153,986 discloses a method of fabricating metal core layers for a multi-layer circuit board. Suitable dielectrics include vapor-depositable conformal polymeric coatings. The method uses solid metal cores and the reference describes in broad, generic terms circuitization of the substrate.

Circuitization of intermediate package levels is conventionally performed by applying a positive- or negative-acting photoresist to the metallized substrate, followed by exposure, development, and stripping to yield a desired circuit pattern. Photoresist compositions are typically applied by laminating, spraying, or immersion. The photoresist layer thus applied may have a thickness of 5 microns to 50 microns.

In addition to the ceramic, fiberglass reinforced polyepoxides, and polyimides mentioned above, conventional substrates used in intermediate package levels further include solid metal sheets such as are disclosed in U.S. Pat. No. 5,153,986. These solid substrates must be perforated during fabrication of the circuit assembly to provide through holes for alignment purposes.

In view of the prior art processes, it would be desirable to provide a process for preparing a multi-layer circuit assembly that overcomes the drawbacks of the prior art.

### SUMMARY OF THE INVENTION

It is an object of the present invention to provide a process for preparing a multi-layer circuit assembly such that the final assembly comprises component layers having thermal coefficients of expansion that are compatible with those of smaller and larger scale components which may be attached to the circuit assembly.

It is a further object of the present invention to provide high via density, allowing for more electrical interconnects from highly functional chips to level two packages.

Additional objects of the present invention include superior dielectric performance and fine line resolution to provide for advanced chip attachment techniques.

In accordance with the present invention, a process for fabricating a multi-layer circuit assembly is provided comprising the following steps:

(a) providing a perforate metal core;

(b) applying a dielectric polymer to all exposed surfaces of the metal core to form a conformal coating of substantially uniform thickness on all exposed surfaces of the metal core;

(c) ablating the surface of the dielectric polymer in a predetermined pattern to expose sections of the metal core;

(d) applying a layer of metal to all surfaces thereby forming metallized vias through the metal core; and

(e) applying a resinous photosensitive layer to the metal layer.

### BRIEF DESCRIPTION OF THE DRAWINGS

FIG. 1 is a flow chart depicting an embodiment of the process of the invention.

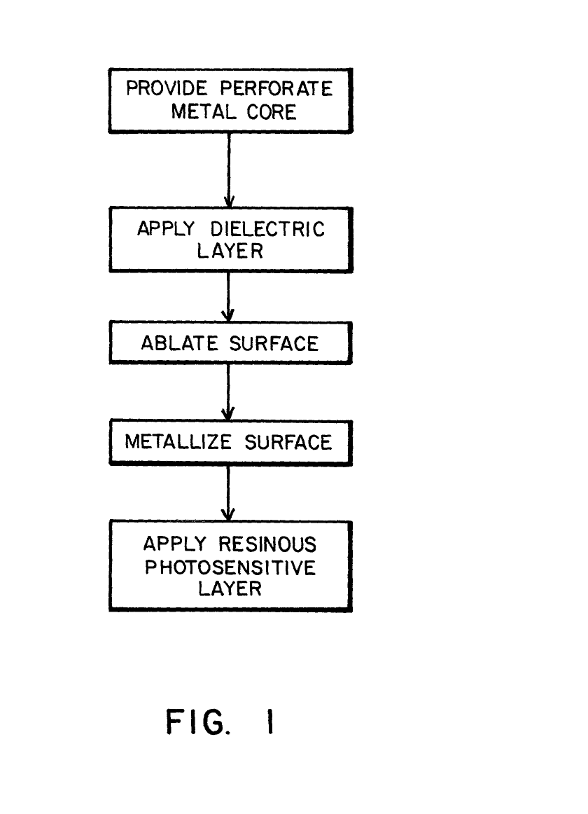

FIG. 2 is a flow chart depicting an additional embodiment of the present invention, including circuitization of the multi-layer assembly.

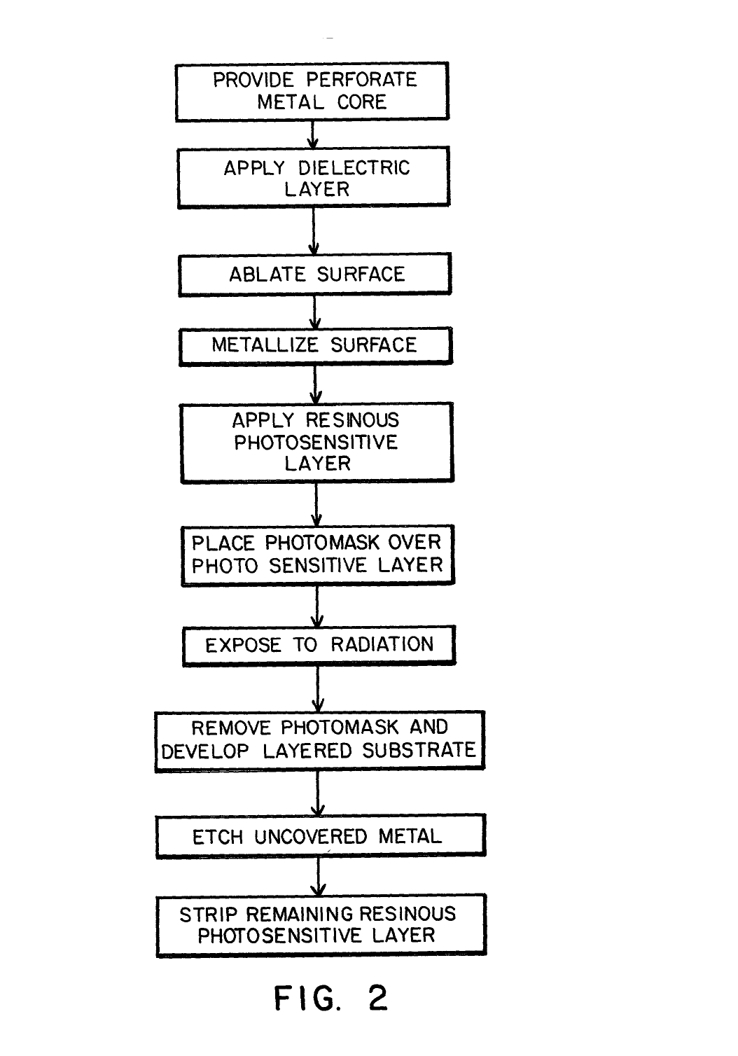

### DETAILED DESCRIPTION

The process of the present invention for fabricating a multi-layer circuit assembly comprises the following steps:

(a) providing a perforate metal core;

(b) applying a dielectric polymer to all exposed surfaces of the metal core to form a conformal coating of substantially uniform thickness on all exposed surfaces of the metal core;

(c) ablating the surface of the dielectric polymer in a predetermined pattern to expose sections of the metal core;

(d) applying a layer of metal to all surfaces thereby forming metallized vias through the metal core; and

(e) applying a resinous photosensitive layer to the metal layer.

In a separate embodiment, the process of the present invention for fabricating a multi-layer circuit assembly comprises the following steps: (a) through (e) as above;

(f) placing a photo-mask having a desired pattern over the photosensitive layer to form a layered substrate with selected exposed portions;

(g) exposing the layered substrate to a suitable actinic radiation source;

(h) removing the photo-mask and developing the layered substrate to remove more soluble portions of the photosensitive layer from the underlying metal layer and to uncover selected areas of the metal layer;

(i) etching any uncovered metal to remove it from the underlying dielectric polymer; and

(j) stripping the remaining resinous photosensitive layer to provide a circuit pattern connected by the metallized vias formed in step (d).

The process may include one or more other optional steps, as discussed below, with the same results and without departing from the scope of the invention.

The substrate used in the process of the present invention is a perforate metal core having a thickness of about 15 to 250 microns, preferably 25 to 100 microns. By “perforate metal core” is meant a mesh sheet having a plurality of holes spaced at regular intervals. Typically the holes are of uniform size and shape. The diameter of the holes is about 8 mil (203.2 microns), but may be larger or smaller as necessary, with the proviso that the hole is large enough to accommodate all the layers applied in the process of the present invention without becoming obstructed. The spacing of the holes is about 20 mils (508 microns) center-to-center, but again may be larger or smaller as necessary. Via density may range from 500 to 10,000 holes/square inch (75 to 1550 holes/square centimeter), preferably about 2500 holes/square inch (387.5 holes/square centimeter).

Suitable metals include copper foil, iron-nickel alloys, and combinations thereof. A preferred iron-nickel alloy is Invar, (trademark owned by Imphy S. A., 168 Rue de Rivoli, Paris, France) comprising approximately 64 weight percent iron and 36 weight percent nickel. This alloy has a low coefficient of thermal expansion, comparable to that of silicon materials used to prepare chips. This property is desirable in order to prevent failure of adhesive joints between successively larger or smaller scale layers of a chip scale package, due to thermal cycling during normal use. When a nickel-iron alloy is used as the metal core, a layer of copper metal is preferably applied to all surfaces of the metal core to ensure optimum conductivity. The layer of copper metal may be applied by conventional means, such as electroplating. The layer of copper typically has a thickness of from 1 to 8 microns.

A dielectric polymer is applied to all exposed surfaces of the metal core to form a conformal coating of substantially uniform thickness, typically about 5 to 50 microns on all exposed surfaces of the metal core. The dielectric polymer used in the process of the present invention may be applied by any conformal coating method including vapor deposition and electrodeposition. Examples of dielectric coatings applied by vapor deposition include poly-(para-xylylene), substituted poly-(para-xylylene), poly-benzocyclobutene and polyimide. Examples of dielectric coatings applied by electrodeposition include anodic and cathodic acrylic, epoxy, polyester, polyurethane, polyimide or oleoresinous compositions, as known to those skilled in the art. After application of the dielectric polymer, the surface of the dielectric polymer is ablated in a predetermined pattern to expose sections of the metal core. Such ablation is typically performed using a laser or by other conventional techniques.

Prior to application of the dielectric, the metal core surface may be pretreated or otherwise prepared for the application of the dielectric. For example, cleaning, rinsing, and/or treatment with an adhesion promoter prior to application of the dielectric may be appropriate.

Metallization is performed after the ablation step by applying a layer of metal to all surfaces, allowing for the formation of metallized vias through the metal core perforations. Suitable metals include copper or any metal or alloy with sufficient conductive properties. The metal is typically applied by electroplating or any other method providing a uniform metal layer. The thickness of the metal layer is typically about 5 to 50 microns.

To enhance the adhesion of the metal layer to the dielectric polymer, prior to the metallization step all surfaces are preferably treated with ion beam, electron beam, corona discharge or plasma bombardment followed by application of an adhesion promoter layer to all surfaces. The adhesion promoter layer is about 50 to 5000 Ångstroms thick and is typically a metal or metal oxide selected from chromium, titanium, nickel, cobalt, cesium, iron, aluminum, copper, gold, and zinc, and oxides thereof.

After metallization, a resinous photosensitive layer (“photoresist”) is applied to the metal layer. Optionally, prior to application of the photoresist, the metallized substrate can be cleaned and pretreated; e.g., treated with an acid etchant to remove oxidized metal. The resinous photosensitive layer can be a positive or negative photoresist. The photoresist layer typically has a thickness of about 2 to 50 microns and can be applied by any method known to those skilled in the photolithographic processing art. Additive or subtractive processing methods may be used to create the desired circuit patterns.

Suitable positive-acting photosensitive resins include any of those known to practitioners skilled in the art. Examples include dinitro-benzyl functional polymers such as those disclosed in U.S. Pat. No. 5,600,035, columns 3-15. Such resins have a high degree of photosensitivity. In one embodiment, the resinous photosensitive layer is a composition comprising a dinitro-benzyl functional polymer, typically applied by spraying.

In a separate embodiment, the resinous photosensitive layer is an electrodepositable composition comprising a dinitrobenzyl functional polyurethane and an epoxy-amine polymer such as that described in Examples 3-6 of U.S. Pat. No. 5,600,035.

Negative-acting photoresists include liquid or dry-film type compositions. Liquid compositions may be applied by rolling application techniques, curtain application, or electrodeposition. Preferably, liquid photoresists are applied by electrodeposition, more preferably cationic electrodeposition. Electrodepositable compositions comprise an ionic, polymeric material which may be cationic or anionic, and may be selected from polyesters, polyurethanes, acrylics, and polyepoxides. Examples of photoresists applied by anionic electrodeposition are shown in U.S. Pat. No. 3,738,835. Photoresists applied by cationic electrodeposition are described in U.S. Pat. No. 4,592,816. Examples of dry-film photoresists include those disclosed in U.S. Pat. Nos. 3,469,982, 4,378,264, and 4,343,885. Dry-film photoresists are typically laminated onto the surface such as by application of hot rollers.

Note that after application of the photosensitive layer in step (e), the multi-layer substrate may be packaged at this point allowing for transport and processing of any subsequent steps at a remote location.

In a separate embodiment of the invention, after the photosensitive layer is applied in step (e), a photo-mask having a desired pattern may be placed over the photosensitive layer as in step (f) and the layered substrate exposed to a sufficient level of a suitable actinic radiation source as in step (g). As used herein, the term “sufficient level of actinic radiation” refers to that level of radiation which polymerizes the monomers in the radiation-exposed areas in the case of negative acting resists, or which depolymerizes the polymer or renders the polymer more soluble in the case of positive acting resists. This results in a solubility differential between the radiation-exposed and radiation-shielded areas.

The photo-mask may be removed after exposure to the radiation source and the layered substrate developed using conventional developing solutions to remove more soluble portions of the photosensitive layer, and uncover selected areas of the underlying metal layer as recited in step (h).

The metal uncovered during step (h) may then be etched using metal etchants which convert the metal to water soluble metal complexes. The soluble complexes may be removed by water spraying.

The photosensitive layer protects any metal thereunder during the etching step (i). The remaining photosensitive layer, which is impervious to the etchants, may then be removed as in step (j) by a chemical stripping process to provide a circuit pattern connected by the metallized vias formed in step (d).

After preparation of the circuit pattern on the multi-layered substrate, other circuit components may be attached to form a circuit assembly, in a subsequent step (k). Additional components include one or more smaller scale components such as semiconductor chips, interposer layers, larger scale circuit cards or mother boards and active or passive components. Note that interposers used in the preparation of the circuit assembly may be prepared using appropriate steps of the process of the present invention. Components may be attached using conventional adhesives, surface mount techniques, wire bonding or flip chip techniques. High via density in the multi-layer circuit assembly prepared in accordance with the present invention allows for more electrical interconnects from highly functional chips to the packages in the assembly.

We claim:

1. A process for fabricating a multi-layer circuit assembly comprising the following steps:
(a) providing a perforate metal core;
(b) applying a dielectric polymer onto all exposed surfaces of the metal core to form a conformal coating of substantially uniform thickness on all exposed surfaces of the metal core;
(c) ablating the surface of the dielectric polymer in a predetermined pattern to expose sections of the metal core;
(d) applying a layer of metal to all surfaces to form metallized vias through the metal core; and
(e) applying a resinous photosensitive layer to the metal layer.

2. The process of claim 1 wherein the metal core is selected from perforate copper foil, iron-nickel alloys, and combinations thereof.

3. The process of claim 2 wherein the metal core is a nickel-iron alloy.

4. The process of claim 3 wherein before application of the dielectric polymer a layer of copper metal is applied to the metal core.

5. The process of claim 1 wherein the dielectric polymer is applied by vapor deposition.

6. The process of claim 5 wherein the dielectric polymer is a poly (para-xylylene).

7. The process of claim 1 wherein the dielectric polymer is applied by electrodeposition.

8. The process of claim 1 wherein prior to step (d) all surfaces are treated with ion beam, electron beam, corona discharge or plasma bombardment followed by application of an adhesion promoter layer to all surfaces.

9. The process of claim 8 wherein the adhesion promoter layer is a metal or metal oxide selected from chromium, titanium, nickel, cobalt, cesium, iron, aluminum, copper, gold, and zinc.

10. The process of claim 1 wherein the layer of metal applied in step (d) is a layer of copper.

11. The process of claim 1 wherein the resinous photosensitive layer applied in step (e) is a positive-acting photosensitive layer applied by electrodeposition.

12. The process of claim 1 wherein the perforate metal core has a via density of 500 to 10,000 holes/square inch (75 to 1550 holes/square centimeter).

13. A process for fabricating a multi-layer circuit assembly comprising the following steps:
(a) providing a perforate metal core;
(b) applying a dielectric polymer onto all exposed surfaces of the metal core to form a conformal coating of substantially uniform thickness on all exposed surfaces of the metal core;
(c) ablating the surface of the dielectric polymer in a predetermined pattern to expose sections of the metal core;
(d) applying a layer of metal to all surfaces to form metallized vias through the metal core;
(e) applying a resinous photosensitive layer to the metal layer;
(f) placing a photo-mask having a desired pattern over the photosensitive layer to form a layered substrate with selected exposed portions;
(g) exposing the layered substrate to a suitable actinic radiation source;
(h) removing the photo-mask and developing the layered substrate to remove more soluble portions of the photosensitive layer from the underlying metal layer and to uncover selected areas of the metal layer;
(i) etching any uncovered metal to remove it from the underlying dielectric polymer; and
(j) stripping the remaining resinous photosensitive layer to provide a circuit pattern connected by the metallized vias.

14. The process of claim 13 further comprising the step of:
(k) attaching other circuit components.

15. The process of claim 14 wherein the assembly is packaged after step (e) allowing for transport and subsequent processing of steps (f) through (k) at a remote location.

16. The process of claim 13 wherein the perforate metal core has a via density of 500 to 10,000 holes/square inch (75 to 1550 holes/square centimeter).

17. The process of claim 13 wherein the metal core is selected from perforate copper foil, iron-nickel alloys, and combinations thereof.

18. The process of claim 17 wherein the metal core is a nickel-iron alloy.

19. The process of claim 18 wherein before application of the dielectric polymer a layer of copper metal is applied to the metal core.

20. The process of claim 13 wherein the dielectric polymer is applied by vapor deposition.

21. The process of claim 20 wherein the dielectric polymer is a poly (para-xylylene).

22. The process of claim 13 wherein the dielectric polymer is applied by electrodeposition.

23. The process of claim 13 wherein prior to step (d) all surfaces are treated with ion beam, electron beam, corona discharge or plasma bombardment followed by application of an adhesion promoter layer to all surfaces.

24. The process of claim 23 wherein the adhesion promoter layer is a metal or metal oxide selected from chromium, titanium, nickel, cobalt, cesium, iron, aluminum, copper, gold, and zinc.

25. The process of claim 13 wherein the layer of metal applied in step (d) is a layer of copper.

26. The process of claim 13 wherein the resinous photosensitive layer applied in step (e) is a positive-acting photosensitive layer applied by electrodeposition.
